(19) United States
(12) Patent Application Publication
(10) Pub. No.: US 2021/0352111 A1
(43) Pub. Date: Nov. 11, 2021

(54) PASS BRIDGE SYSTEM (PROCESS AUTHORIZATION SAFETY/SECURITY)

(71) Applicant: NILESHKUMAR CHRISTIAN, LANCASTER, PA (US)

(72) Inventor: NILESHKUMAR CHRISTIAN, LANCASTER, PA (US)

(21) Appl. No.: 16/886,751

(22) Filed: May 28, 2020

Related U.S. Application Data
(60) Provisional application No. 62/704,433, filed on May 10, 2020.

(51) Int. Cl. H04L 29/06; G06N 20/00; G06N 5/04; G06F 13/42

(52) U.S. Cl. CPC H04L 63/20; H04L 63/08; G06N 20/00; G06F 2213/0042; G06F 13/4282; H04L 2463/082; G06N 5/04

(57) ABSTRACT

A Process Authorization Safety/Security Bridge System (PASS) is an interface system or an equipment or a machine or a method of interface consisting of three essential components (1) Hardware Device (2) Wireless Device (3) Software Interface. PASS Bridge System is an interface or equipment or machine or method of interface. It has the ability to interface with process(s) or mission critical process(s) or equipment or machines or process controllers and enable the underlying process(s) to leverage multi factor authentication (MFA) capability of PASS Bridge System and establish process(s) access accountability and safety tracking/tracing. The PASS Bridge System can be used as a bridge or interface method or interface system to provide “TRUSTED ACCESS” process safety policy to any mission critical process(s) or any industrial process(s) or any process(s).

### BACKGROUND

Multi Factor Authentication (MFA) technologies have recently been studied a lot due to an enormous number of security breaches. MFA technologies offer best possible protection against unauthorized access. The term “TRUSTED ACCESS” policy is considered very important in terms of protection of assets and resources. Any system that can implement “TRUSTED ACCESS” policy stands a fair chance of withstanding unauthorized intrusion attacks aimed at hurting personnel and/or damaging resources. An ideal “TRUSTED ACCESS” policy system has three components: (1) physical hardware (2) wireless device (cellular phone) (3) software system. These three when interfaced together will create a best possible “TRUSTED ACCESS” policy system. This type of “TRUSTED ACCESS” policy system is also capable of making processes safer and more secure. General utilization of “TRUSTED ACCESS” policy systems are mainly focused on network security. The existing older technology does not offer “TRUSTED ACCESS” policy architecture. Current invention is an attempt to bridge that gap by providing the same robust “TRUSTED ACCESS” policy interface via external bridge subsystem to an existing older industrial processes using underlying industrial hardware as a “TRUSTED ACCESS” policy enforcer and proprietary software interface as a “TRUSTED ACCESS” policy decision maker.

### BRIEF SUMMARY OF THE INVENTION

The following is intended to be a brief summary of the invention and is not intended to limit the scope of the invention.

Industrial controls are mostly designed to control mission critical processes, and most of the time they process critical functional parameters.

In processes where the process controllers are of older architecture, the processes are more functionality oriented rather than security oriented.

The “TRUSTED ACCESS” policy systems are more recently being studied and adapted in newer technologies. These newer process controllers are used in industrial applications and can provide both functional as well as security oriented architecture.

The lack of “TRUSTED ACCESS” policy in existing older process controllers has created a necessity to invent a bridge solution which can add “TRUSTED ACCESS” functionality to any mission critical process.

The Process Authorization Safety: Security Bridge System (PASS) has an added advantage of providing safety as well as security to mission critical processes.

The Process Authorization Safety/Security Bridge System (PASS) can interface to any process application using (1) hardware, (2) wireless, (3) software interface thus making it an ideal solution to achieve “TRUSTED ACCESS” policy for mission critical processes.

### BRIEF DESCRIPTION OF THE DRAWINGS

FIG. 1. Electrical schematic diagram, CAD drawing of the hardware and panel for PASS Bridge System 120VAC/24VDC Control Wiring

FIG. 2. Electrical schematic diagram. CAD drawing hardware and panel for PASS Bridge System specifically DC Inputs/Outputs

FIG. 3. Mechanical layout, CAD drawing of the mechanical layout for PASS Bridge System hardware components

FIG. 4. Mechanical layout, CAD drawing of the PASS Bridge System panel front exterior layout

### DETAIL DESCRIPTION AND BEST MODE OF IMPLEMENTATION

In one embodiment, the present invention is a “TRUSTED ACCESS” policy bridge system interface which includes all three (3) most important aspects of a “TRUSTED ACCESS” policy as one complete interface with (1) Hardware (2) Wireless Device (3) Software Interface.

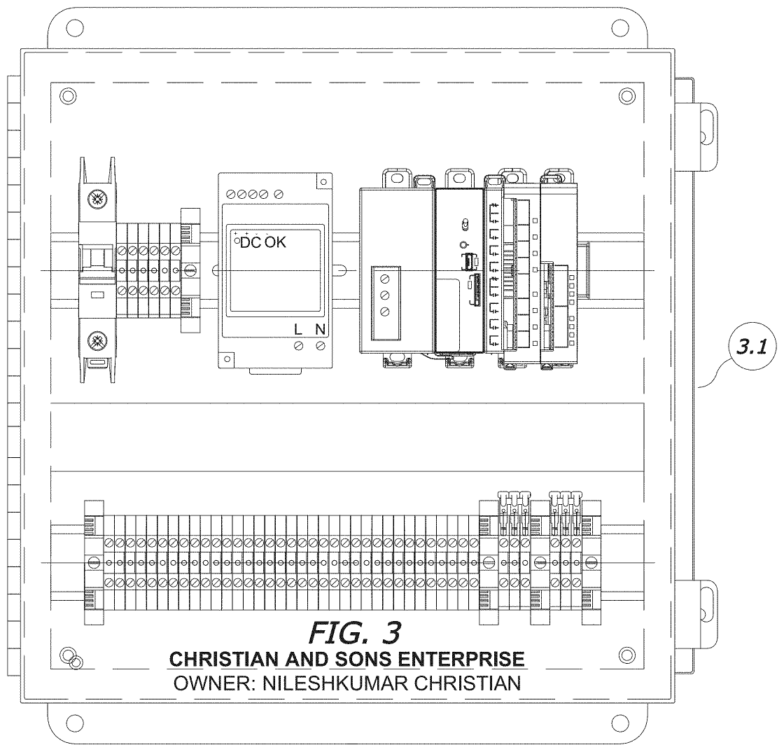

In one aspect of invention it uses a hardware component which is a main hardware intelligence to achieve “TRUSTED ACCESS” policy interface for any mission critical process that is trying to add process safety and security. The hardware intelligence component is enclosed in an industrial panel as per FIG. 3(3.1). The industrial panel is a standard industrial panel with NEMA 3R ratings. The dimensions of the panel are 12″×12″×6″ inch. The panel is a standard industrial panel made out of carbon steel with ANSI 61 gray, galvanized and powder coated finish. It has a standard single door, a quick release latch, padlock hasp and staple. Panel has a standard wall mount bracket and standard knockouts for cable runs.

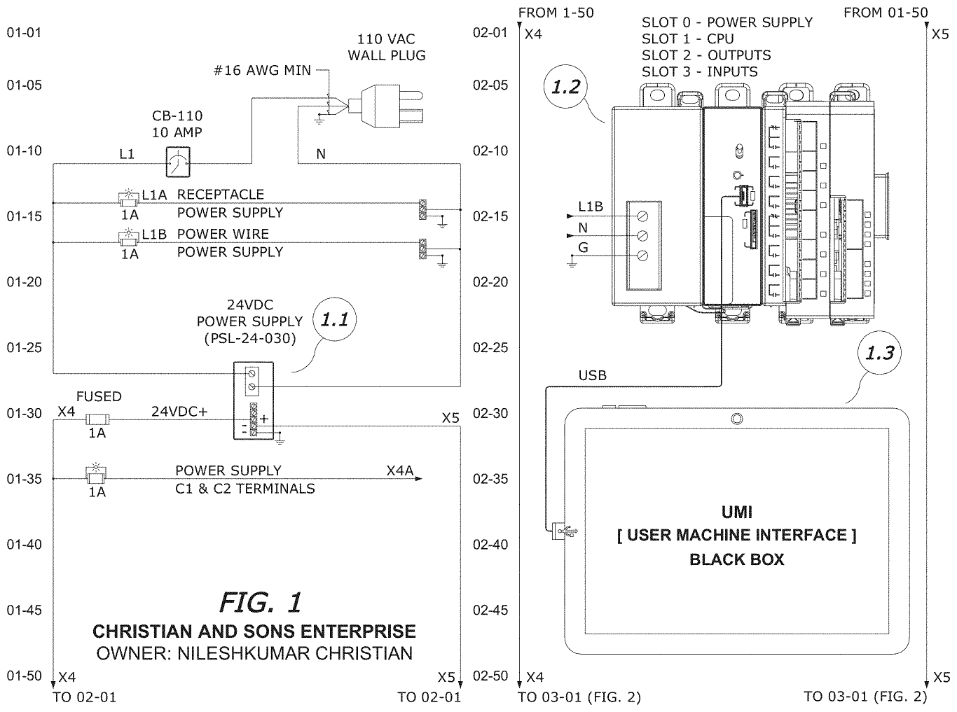

The present invention, hardware component enclosed inside an industrial panel has a Programmable Logical Controller (PLC) which is a main hardware intelligence as shown in FIG. 1(1.2). The PLC provides a necessary hardwired intelligent interface for mission critical processes that are trying to add process safety and security. The PLC System consists of a CPU Model P1AM-100. The PLC System CPU backplane is powered by 110VAC power supply Model P1-01AC. There is one input card Model P1-08NE3 connected on the CPU backplane. Also there is one output card Model P1-08TRS connected on the CPU backplane. The Input/Output cards are powered by a separate 24VDC power supply Model PSL-24-030 as per FIG. 1(1.1). The PLC system and power supply components are mounted on DIN rail and DIN rail is mounted on top of panel insert which is enclosed inside the panel.

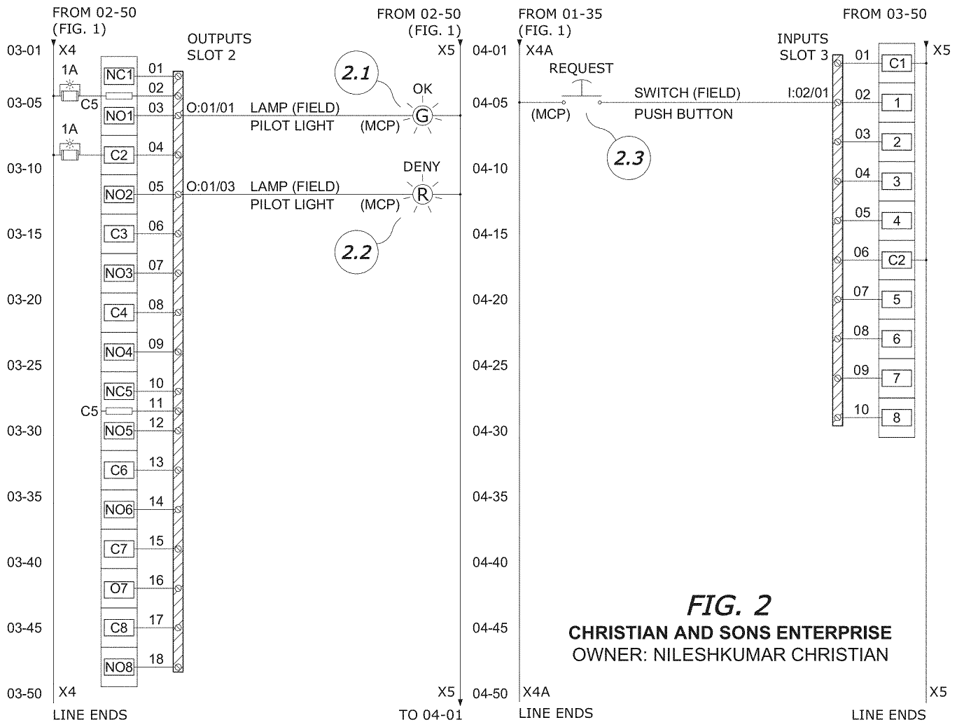

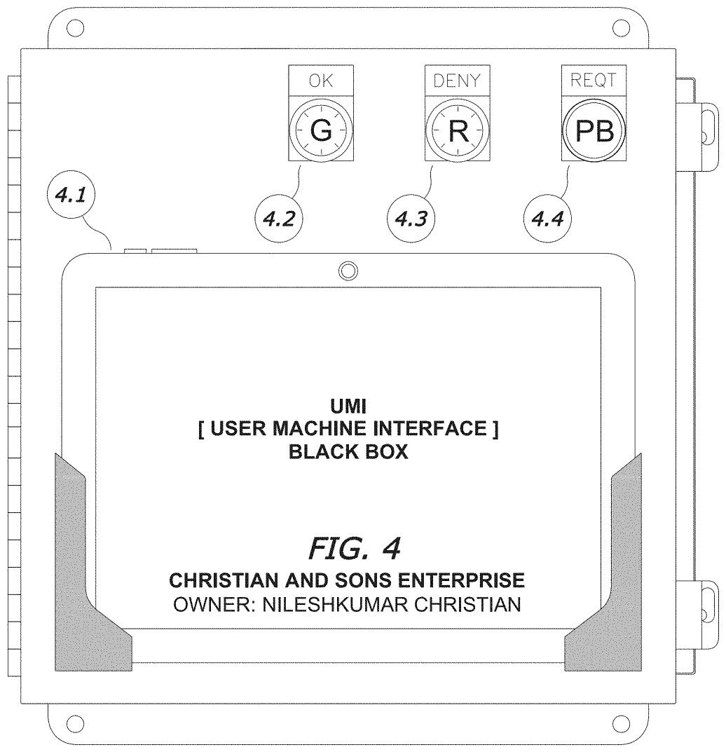

The working panel example as shown in FIG. 2 is an attempt to demonstrate an interface to a single mission critical process. These input/output connections are required for any mission critical process that wants to interface to the PASS Bridge System in order to achieve “TRUSTED ACCESS” policy. As shown in FIG. 2(2.3) there is one input to the PASS Bridge System from the mission critical process. This input is a “REQUEST” for authorization from a mission critical process. As shown in FIG. 2(2.1 and 2.2) there are two relay outputs from the PASS Bridge System to the mission critical process. These outputs are a “RESPONSE” from PASS Bridge System to the mission critical process. As shown in FIG. 4(4.2 and 4.3) the two “RESPONSE” feedbacks which are classified as “OK” and “DENY” are represented as Green and Red Pilot light respectively. These pilot lights in actual practical installations will be feedback relay outputs sending signals to the mission critical system to allow it to enforce “TRUSTED ACCESS” policy.

In the second aspect of invention as shown in FIG. 1 there is a USB serial connection from PLC CPU Model P1AM-100 to a “BLACK BOX”. The “BLACK BOX” is a proprietary User Machine Interface (UMI) software device as per FIG. 1(1.3). One of the requirements of “TRUSTED ACCESS” policy is a secure network connection from policy enforcing hardware to policy decision making software interface. A USB serial communication connection provides a secure connection necessary for this type of software interface communication. The “BLACK BOX” is a proprietary software interface and due to the proprietary nature of the software it is beyond the scope of this specification document and it is documented in FIG. 1(1.3) as a “BLACK BOX” User Machine Interface (UMI).

Under normal operating conditions when the mission critical process needs to enforce “TRUSTED ACCESS” policy, it enables a hardwired interfaced signal herein referred to as a “REQUEST” to “TRUSTED ACCESS” policy enforcer herein referred to as PLC CPU hardware. PLC CPU hardware communicates the “REQUEST” command to Process Authorization Safety/Security Bridge System (PASS), policy decision maker herein referred to as a “BLACK BOX” via USB serial communication link. The “TRUSTED ACCESS” policy decision maker “BLACK BOX” sends appropriate feedback “RESPONSE” to allow “TRUSTED ACCESS” policy enforcer PLC CPU hardware to generate necessary hardwired interfaced signals via “OK” or “DENY” feedback relays.

In the third aspect of invention a wireless device is used as a user interacted decision making device. The “BLACK BOX” receives and forwards the “REQUEST” for authorization via wireless cellular signal to the user wireless device. The wireless device needs to be registered with the “BLACK BOX” interface software so that it will be recognized as a valid authorization device. The wireless device also needs to have a proprietary software interface to interact with the “BLACK BOX”. When a “REQUEST” is forwarded to an authorized wireless device it will activate a user response message screen on the wireless device with two options “OK” and “DENY” respectively. A user can choose the response answer thus providing the physical human decision making aspect of “TRUSTED ACCESS” policy. The user selected “RESPONSE” is then sent back to “BLACK BOX” software interface which then forwards feedback “RESPONSE” to PLC CPU hardware. PLC CPU hardware activates appropriate hardwired feedback signals to the mission critical process and completes the “TRUSTED ACCESS” policy cycle.

In present invention “BLACK BOX” user machine interface is operated by proprietary software. The proprietary software has two different types of communication protocols. Both the protocols are also of proprietary nature. First communication is USB serial connection with the PLC CPU hardware device. Second communication is with a wireless device via cellular wireless connection. Both protocols are part of the “BLACK BOX” software interface and they are of proprietary nature, which is beyond the scope of this specification document.

Current invention can be interfaced with many types of processes and machines. In one aspect of the mission critical process a safety gate control or an industrial machine or robot safety gate control which controls entry/exit of personnel to machine or robot cage(s) can interface with current invention to make the personnel exit safety procedure more trustworthy and accountable.

Current invention can be interfaced with a process which uses many different recipes. When there are more than one recipes in the process, the updates or changes to the currently running recipe becomes a mission critical process. Current invention can interface with a multi-recipe process to enforce “TRUSTED ACCESS” policy. When a change of recipe is enforced by the current invention the recipe change process will be more trustworthy and accountable.

Current invention can be interfaced with any process which utilizes mission critical fault reset functions. When it is interfaced with current invention any mission critical fault reset system will require “TRUSTED ACCESS” policy enforcer and decision maker. This makes the fault reset process more trustworthy and accountable.

Current invention can be interfaced or bridged with any existing gate or door or building access system. When it is interfaced with current invention any gate or door access system will require a “TRUSTED ACCESS” policy enforcer and decision maker to open the access gate or door. This makes the gate or door access system more trustworthy and. accountable.

### REFERENCES (INCORPORATED HEREIN BY REFERENCE)

1. Automation Direct P1AM-100 user manual number: P1AM-USER-M https://cdn.automationdirect.com/static/manuals/pluserm/pluserm.pdf

2. Hammond Manufacturing NEMA 3R rated enclosure C3R1 2126HCR Technical Specification manual https://cdn.automationdirect.com/static/specs/h_n3r_paint_galvst_sdwm_ko.pdf
3. RHINO PSL Series PSL-24030 Technical Specification manual https://cdn.automationdirect.com/static/specs/pslpowersupplies.pdf

I CLAIM

1. The current invention is a Bridge System or an Interface System or an Equipment Interface or a Method of Interface that interacts with existing mission critical process(s) or an industrial process(s) or equipment(s) or machine(s) or any process(s) to enforce existing or non-existing “TRUSTED ACCESS” policy within mission critical process(s) or equipment(s) or machine(s),

2. The Bridge System or Interface System or an Equipment Interface or a Method of Interface of claim 1, further comprises multi factor authentication via hardware intelligence or hardware system intelligence or such form of intelligence system which acts as a “TRUSTED ACCESS” policy enforcer as per FIG. 1 and FIG. 2.

3. The Bridge System or Interface System or an Equipment Interface or a Method of Interface of claim 1 and intelligent policy enforcer method or system or equipment of claim 2, further comprises policy decision maker wherein a proprietary software designed in current invention is used to make a decision based on physical user action via a physical wireless device and thus acts as a policy decision making system or equipment or interface or machine.

4. The Bridge System or Interface System or an Equipment Interface or a Method of Interface of claim 1, comprises of hardware interface signals to transfer “REQUEST” and “RESPONSE” signals with single connection USB serial communication between policy decision maker and policy decision enforcer, making existing or non-existing “TRUSTED ACCESS” policy reliable and enforceable hence making current invention a “TRUSTED ACCESS” policy decision maker, enforcer and executioner.

5. The purpose of the current invention as in claim 1 is to establish a method or system or equipment or machine to allow existing process(s) or mission critical process(s) or equipment(s) or machine(s) to track and trace safety access(s) wherein accountability is established hence making a personnel safety and resource security a prime objective and ultimately saving lives of people (in honor of a friend N. Sullivan who lost his life in a robot work accident, May God Rest his Soul in Peace).
